(19) United States
(12) Patent Application Publication
(10) Pub. No.: US 2026/0331790 A1
(43) Pub. Date: Oct. 22, 2026

(54) CONTACT ARRANGEMENT, DRIVE UNIT AND BRAKING SYSTEM

(71) Applicant: Robert Bosch GmbH, Stuttgart (DE)

(72) Inventors: Andreas Bentele, Sulzberg (DE); Ingmar Joas, Feuchtwangen (DE); Javier Bores Rangel, Vaihingen-Kleinglattbach (DE); Konstantinos Gkoutzos, Neckarweihingen-Ludwigsburg (DE); Martin Winkler, Sonthofen (DE)

(21) Appl. No.: 19/653,730

(22) Filed: Apr. 21, 2026

(30) Foreign Application Priority Data
Apr. 22, 2025 (DE) 10 2025 115 381.7

(51) Int. Cl. H01R 4/48; F16D 121/18

(52) U.S. Cl. CPC H01R 4/48; F16D 2121/18

(57) ABSTRACT

A contact arrangement for a first housing, in particular of an electronic unit, and a second housing, in particular of a transmission unit. The contact arrangement has a centering pin and a spring element, wherein the centering pin and the spring element are receivable at least partially in a centering recess of the first housing, wherein an electrically conductive connection can be established from the second housing into an interior of the first housing through the centering recess using the centering pin and the spring element.

### CROSS REFERENCE

The present application claims the benefit under 35 U.S.C. § 119 of Germany Patent Application No. DE 10 2025 115 381.7 filed on Apr. 22, 2025, which is expressly incorporated herein by reference in its entirety.

### FIELD

The present disclosure relates to a contact arrangement, a drive unit, and a braking system.

### BACKGROUND INFORMATION

Germany Patent Application No. DE 10 2023 206 645 A1 shows a contact rivet for electrical ground contacting and a contact arrangement.

Germany Patent Application NO. DE 10 2020 123 816 A1 describes a control unit with a contacting concept for a ground connection when implementing a plastics material housing along with a drive module.

### SUMMARY

A feature of the present disclosure in the case of the contact arrangement for a first housing, in particular of an electronic unit, and a second housing, in particular of a transmission unit, is that the contact arrangement has a centering pin and a spring element, wherein the centering pin and the spring element are receivable at least partially in a centering recess of the first housing, wherein an electrically conductive connection can be established from the second housing into an interior of the first housing through the centering recess by means of the centering pin and the spring element.

The background of the present disclosure is that the contact arrangement is usable as an EMC contact, and, at the same time, functions as a centering device for the first and second housing. As a result, component costs are reducible and the limited installation space can be used optimally.

Further advantageous embodiments of the present disclosure are described herein.

According to an advantageous example embodiment, the centering pin functions as a sealing element, in particular wherein a labyrinth seal is formed between the centering pin and the centering recess. A dust-tight connection is thereby created. Thus, an additional seal can be omitted.

It is advantageous if the centering recess has, in an end portion, a cross section that increases toward the second housing. Thus, the centering recess functions as an insertion aid for the centering pin.

According to a further advantageous example embodiment, a circuit board is arranged in the first housing, which is electrically conductively connected to the spring element, in particular so that an electrically conductive connection can be established from the second housing to the circuit board through the centering recess by means of the centering pin and the spring element. As a result, a reliable and compact ground connection is created for the circuit board.

It is advantageous if the spring element is holdable or held in a prestressed manner between the circuit board and the centering pin, is connectable or connected at one end to the circuit board, and is arrangeable or arranged with the other end bearing against an end face of the centering pin. Thus, a secure, electrically conductive connection is created.

Advantageously, the first housing together with the spring element is pluggable onto the second housing together with the centering pin. The centering pin can be inserted into the centering recess.

Furthermore, it is advantageous if the circuit board has a contact surface for the spring element, in particular wherein the spring element is materially bonded at one end to the contact surface, in particular soldered to the contact surface. As a result, a low-resistance electrically conductive connection between the spring element and the circuit board or the contact surface is created.

Advantageously, the end face of the centering pin facing the spring element has a galvanic coating or a plate which is made of a material having a lower contact resistance than the centering pin, in particular is made of silver and/or gold and/or tin. Thus, the contact resistance between the centering pin and the spring element is reducible. Due to the coating or the plate, it is advantageously ensured that the contact spring element is reliably electrically conductively contacted.

Alternatively or additionally, the centering pin has an electrically conductive surface, in particular an electrically conductive oxide layer. The centering pin can be formed from a copper-nickel-zinc alloy, for example so-called nickel silver.

According to a further advantageous example embodiment, the centering pin is fixedly connected to the second housing, in particular wherein the centering pin is received, in particular press-fitted, in a press-fit opening of the second housing. As a result, a secure mechanical and electrically conductive connection is created between the centering pin and the second housing.

Furthermore, it is advantageous if the first housing is connectable to the second housing, in particular wherein the first housing contacts the second housing at least in portions. The contact arrangement can be configured to be integrated into the housing. Thus, no additional installation space is required for the contact arrangement.

A feature of the present disclosure in the case of the drive unit is that the drive unit comprises an electronic unit having a first housing, a transmission unit having a second housing, and at least one contact arrangement as described above or according to one of the embodiments relating to the contact arrangement.

The background of the present disclosure is that the contact arrangement is usable as an EMC contact, and, at the same time, functions as a centering device for the first and second housing. The contact arrangement can be integrated into the housings. As a result, the drive unit can be configured in a compact manner and the number of components is reducible.

According to an advantageous example embodiment, the drive unit has at least two contact arrangements spaced apart from one another, in particular wherein the contact arrangements are arranged diametrically spaced apart from one another. As a result, a reliable centering of the first housing relative to the second housing during mounting is made possible.

Advantageously, the centering recesses are usable as reference recesses during the production of the first housing and additionally during the mounting of the first housing on the second housing. Thus, manufacturing tolerances are further reducible.

A feature of the present disclosure in the case of the braking system is that the braking system comprises a drive unit as described above or according to rest of the disclosure herein relating to the drive unit.

The background of the present disclosure is that the contact arrangement provides an electrical ground contacting of the control unit via the spring element to the centering pin, which is in turn press-fitted into the second housing of the transmission unit of the actuator unit of the braking system. At the same time, the contact arrangement functions as a centering device. Thus, the braking system can be configured in a compact manner.

The above embodiments and developments may be combined with one another in any reasonable manner. Further possible embodiments, developments and implementations of the present disclosure also include combinations not explicitly mentioned of features of the present disclosure described above or in the following relating to the exemplary embodiments. A person skilled in the art will in particular also add individual aspects as improvements or additions to the relevant basic form of the present disclosure, in view of the disclosure herein.

### BRIEF DESCRIPTION OF THE DRAWINGS

In the following section, the present disclosure is explained on the basis of exemplary embodiments, from which further features may arise, but the scope of the present disclosure is not limited thereto. The exemplary embodiments are shown in the figures.

FIG. 1 is a sectional view of an example contact arrangement 1 according to the present disclosure in a first position.

FIG. 2 is a sectional view of the example contact arrangement 1 according to the present disclosure in a second position.

### DETAILED DESCRIPTION OF EXAMPLE EMBODIMENTS

The contact arrangement 1 shown in the figures is designed for an electronic unit not shown in the figures and a transmission unit.

The electronic unit has at least one first housing 2, which faces the transmission unit. At least one centering recess 5 is arranged in the first housing 2.

By means of the centering recess 5, the first housing 2 of the electronic unit 1 can be aligned relative to a second housing 14 of a transmission unit for connecting the first housing 2 to the second housing 14. For this purpose, at least two centering recesses 5 are arranged spaced apart from one another, in particular diametrically opposite one another, in the first housing 2. The centering recesses 5 are formed as through-holes 5 in the first housing 2.

The first housing 2 is preferably formed from plastics material, in particular as a plastics material injection-molded part. The centering recesses 5 are usable as reference recesses during the production of the first housing 2.

The second housing 14 is preferably formed from light metal, in particular aluminum or an aluminum alloy, or another electrically conductive ductile material. Thus, the second housing is connectable to a ground potential.

The contact arrangement 1 comprises the second housing 14 having at least one press-fit opening 16, at least one centering pin 15, and the first housing 2 having at least one centering recess 5, at least one spring element 13, and a circuit board 12.

The centering pin 15 is cylindrical and electrically conductive, for example metallic. The centering pin 15 is received, in particular press-fitted, in the press-fit opening 16 of the second housing 14. Preferably, the centering pin 15 is formed from a harder material than the second housing 14, for example from steel. Advantageously, an end face of the centering pin 15 facing the first housing 2 has a galvanic coating or a plate which is made of a material having a lower contact resistance than the centering pin 15, for example silver and/or gold and/or tin. Alternatively or additionally, the centering pin 15 can have an electrically conductive surface, for example an electrically conductive oxide layer. The centering pin 15 can be formed from a copper-nickel-zinc alloy, for example so-called nickel silver.

The centering recess 5 is formed as a through-hole in which the centering pin 15 and the spring element 13 are at least partially received. Here, an electrically conductive connection, in particular a ground connection, can be established between the second housing 14 and the circuit board 12 by means of the centering pin 15 and the spring element 13 through the centering recess 5.

At the same time, the centering pin 15 functions as a sealing element between the first housing 2 and the second housing 14. For this purpose, the centering pin 15 is arranged in the centering recess 5 in a particle-tight manner. Advantageously, a type of labyrinth seal is formed between the centering pin 15 and the centering recess 5. The centering recess 5 extends along the centering pin 15, wherein the spacing between the centering recess 5 and the centering pin 15 is minimized at least in one third of the length of the centering pin 15.

The centering recess 5 has, in an end portion facing the second housing 14, a cross section that increases toward the second housing 14, which functions as an insertion aid for the centering pin 15.

The circuit board 12 has a contact surface for the spring element 13, which is not shown in the figures. For example, the spring element 13 is materially bonded at one end to the circuit board 12 or the contact surface, in particular soldered.

The spring element 13 is formed, for example, as an X-shaped or Z-shaped formed spring and has a contact surface for the centering pin 15. Alternatively, the spring element 13 is formed as a helical spring with a bent-out coil end, thus having a contact point for the centering pin 15. Alternatively, the spring element 13 is formed as a helical spring and has, due to its coil, a contact ring for the centering pin 15.

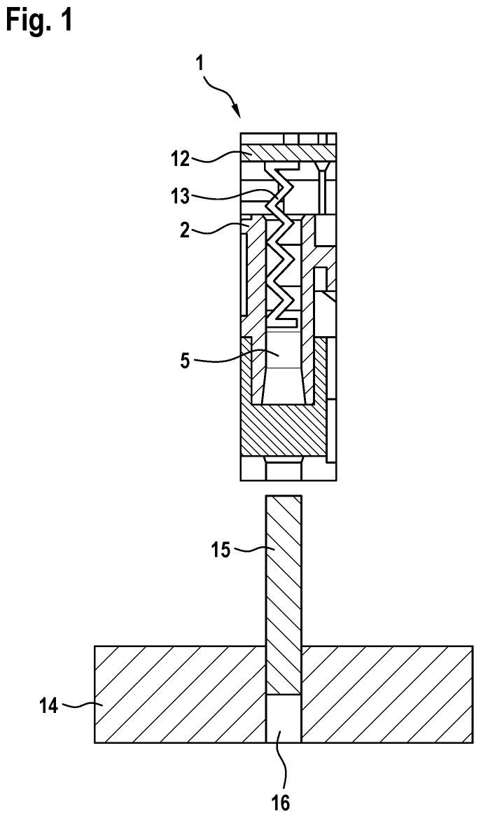

In the first position of the contact arrangement 1, shown in FIG. 1, the second housing 14 and the centering pin 15 are arranged spaced apart from the first housing 2.

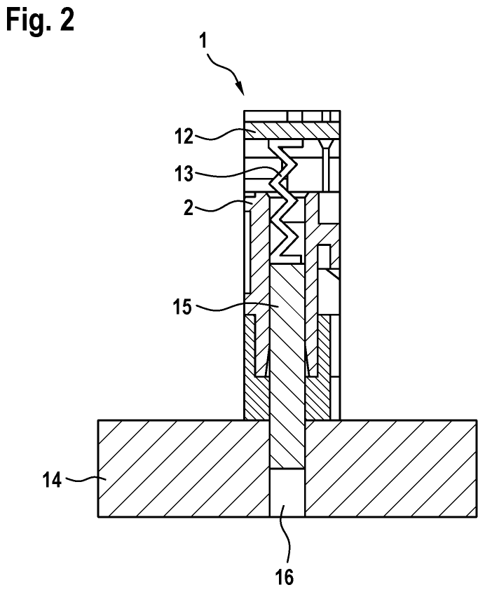

In the second position of the contact arrangement 1, shown in FIG. 2, the centering pin 15 is received in the centering recess 5 of the first housing 2. The centering pin 15 presses with its end face on the spring element 13, so that the spring element is compressed between the circuit board 12 and the centering pin 15 and has a compressive stress.

What is claimed is:

1. A contact arrangement for a first housing, and a second housing, the contact arrangement comprising:
a centering pin and a spring element, wherein the centering pin and the spring element are receivable at least partially in a centering recess of the first housing;
wherein an electrically conductive connection can be established from the second housing into an interior of the first housing through the centering recess using the centering pin and the spring element.

2. The contact arrangement according to claim 1, wherein the first housing is a housing of an electronic unit and the second housing is a housing of a transmission unit.

3. The contact arrangement according to claim 1, wherein the centering pin functions as a sealing element, wherein a labyrinth seal is formed between the centering pin and the centering recess.

4. The contact arrangement according to claim 1, wherein the centering recess has, in an end portion of the centering recess, a cross section that increases toward the second housing.

5. The contact arrangement according to claim 1, wherein a circuit board is arranged in the first housing, which is electrically conductively connected to the spring element, so that an electrically conductive connection can be established from the second housing to the circuit board through the centering recess using the centering pin and the spring element.

6. The contact arrangement according to claim 5, wherein the spring element is holdable or held in a prestressed manner between the circuit board and the centering pin, is connectable or connected at one end of the spring element to the circuit board, and is arrangeable or arranged with another end of the spring element bearing against an end face of the centering pin.

7. The contact arrangement according to claim 5, wherein the circuit board includes a contact surface for the spring element, wherein the spring element is soldered at one end to the contact surface.

8. The contact arrangement according to claim 6, wherein the end face of the centering pin facing the spring element has a galvanic coating or a plate which is made of a material having a lower contact resistance than the centering pin, and is made of silver and/or gold and/or tin.

9. The contact arrangement according to claim 1, wherein the centering pin is fixedly connected to the second housing, and wherein the centering pin is press-fitted in a press-fit opening of the second housing.

10. The contact arrangement according to claim 1, wherein the first housing is connectable to the second housing, and wherein the first housing contacts the second housing at least in portions.

11. A drive unit, comprising:
an electronic unit having a first housing;
a transmission unit having a second housing; and
at least one contact arrangement, including:
a centering pin and a spring element, wherein the centering pin and the spring element are receivable at least partially in a centering recess of the first housing;
wherein an electrically conductive connection can be established from the second housing into an interior of the first housing through the centering recess using the centering pin and the spring element.

12. The drive unit according to claim 11, wherein the drive unit has at least two contact arrangements spaced apart from one another, the contact arrangements are arranged diametrically spaced apart from one another.

13. A braking system, comprising:
a drive unit, including:
an electronic unit having a first housing,
a transmission unit having a second housing, and
at least one contact arrangement, including:
a centering pin and a spring element, wherein the centering pin and the spring element are receivable at least partially in a centering recess of the first housing,
wherein an electrically conductive connection can be established from the second housing into an interior of the first housing through the centering recess using the centering pin and the spring element.
